(19) United States
(12) Patent Application Publication
(10) Pub. No.: US 2022/0193728 A1
(43) Pub. Date: Jun. 23, 2022

(54) CONTROL METHOD AND DEVICE FOR ARTICLE SORTING, AND MEDIUM

(71) Applicant: BEIJING KUANGSHI ROBOTICS TECHNOLOGY CO., LTD., Beijing (CN)

(72) Inventor: Deping CHEN, Beijing (CN)

(21) Appl. No.: 17/605,941

(22) PCT Filed: Aug. 16, 2020
(86) PCT No.: PCT/CN2019/101090

§ 371 Date: Oct. 22, 2021

(30) Foreign Application Priority Data
May 20, 2019 (CN) 201910420877.9

(51) Int. Cl. B07C 3/00; G05B 19/4155

(52) U.S. Cl. CPC B07C 3/006; G05B 2219/45047; G05B 19/4155

(57) ABSTRACT

A control method for article sorting, comprising: acquiring relationship data at least used for reflecting a correspondence between an article list comprising labels of articles to be sorted and a sorting machine; and on the basis of the relationship data, controlling the articles to be sorted that have been selected to be conveyed to the corresponding sorting machine. The described method may improve the degree of automation of the article sorting operation, and increase the operation efficiency. Also disclosed are a control device for article sorting and a readable storage medium.

The present application claims priority to Chinese Patent Application No. 201910420877.9, filed on May 20, 2019, the entire content of which is incorporated herein by reference as a part of the present application.

### TECHNICAL FIELD

Embodiments of the present disclosure relate to a control method and device for article sorting, and a medium.

### BACKGROUND ART

A current article sorting operation has a degree of automation which is not high, and a low operation efficiency, and main reasons may be as follows: a manual sorting manner is commonly adopted in a sorting link, such that the operation efficiency is low, and an error is prone to occurrence; further, since the manual sorting manner has a high error rate, one rechecking operation is usually required to be added in a packaging link, resulting in a higher cost and a great reduction of the operation efficiency.

Therefore, there exists an urgent need for an efficient control method and device for article sorting.

### SUMMARY

In order to solve one of the above problems, the present disclosure provides a control method and device for article sorting, and a medium, so as to efficiently sort articles.

According to an embodiment of the present disclosure, there is provided a control method for article sorting, including: acquiring relationship data at least used for reflecting a correspondence between an article list including labels of articles to be sorted and a sorting machine; and on the basis of the relationship data, conveying the articles to be sorted which have been picked out to the corresponding sorting machine.

According to another embodiment of the present disclosure, there is provided a control device for article sorting, including: an acquiring apparatus, configured to acquire relationship data at least used for reflecting a correspondence between an article list including labels of articles and a sorting machine; and a control apparatus, configured to, on the basis of the relationship data, control the articles to be sorted which have been picked out in the article list to be conveyed to the corresponding sorting machine.

According to still another embodiment of the present disclosure, there is provided a control device for article sorting, including: a processor; and a memory having an executable code stored thereon, which when executed by the processor, causes the processor to perform one of the above-mentioned methods.

According to yet another embodiment of the present disclosure, there is provided a non-transitory machine-readable storage medium having an executable code stored thereon, which when executed by a processor, causes the processor to perform one of the above-mentioned methods.

By acquiring the correspondence between the article list and the sorting machine and controlling the articles to be conveyed to the sorting machine based on the correspondence, a degree of automation of an article sorting operation may be improved effectively, and an operation efficiency may be increased greatly.

### BRIEF DESCRIPTION OF DRAWINGS

Through the more detailed description of exemplary embodiments of the present disclosure in combination with the accompanying drawings, the above and other objects, features and advantages of the present disclosure will become more apparent, wherein the same reference sign generally refers to the same component in the exemplary embodiments of the present disclosure.

FIG. 1 is a schematic flow chart of a control method for article sorting according to an exemplary embodiment of the present disclosure.

FIG. 2 is a schematic flow chart of an exemplary article sorting process.

FIG. 3 is a schematic flow chart of another exemplary article sorting process.

FIG. 4 is a schematic flow chart of another exemplary article sorting process.

FIG. 5 is a schematic flow chart of another exemplary article sorting process.

FIG. 6 is a schematic flow chart of another exemplary article sorting process.

FIG. 7 is a schematic flow chart of another exemplary article sorting process.

FIG. 8 is a schematic block diagram of a control device for article sorting according to an exemplary embodiment of the present disclosure.

FIG. 9 is a schematic block diagram of a control device for article sorting according to another exemplary embodiment of the present disclosure.

### DETAILED DESCRIPTION OF EMBODIMENTS

Some embodiments of the present disclosure will be described in detail with reference to the accompanying drawings hereinafter. Although some embodiments of the present disclosure are illustrated in the accompanying drawings, it should be understood that the present disclosure may be embodied in many different forms and should not be construed as being limited to the embodiments set forth herein. Rather, these embodiments are provided so that this disclosure will be more thorough and complete and will fully convey the scope of the present disclosure to those skilled in the art. It should be noted that the numbers, serial numbers and reference numerals in the present disclosure are only presented for convenience of description, and do not constitute any limitation to the steps, sequence, or the like, of the present disclosure, unless the specific sequence of execution of the steps is explicitly indicated in the specification.

The present disclosure provides a technical solution with which articles may be sorted efficiently.

Herein, the term “article” may include an ordered commodity, or be other articles for management. Additionally, the term “list” herein includes an order for commodities and other forms of article lists. That is, the technical solution of the present disclosure should not be limited to application to the commodity order, but may also be applied to other fields, such as warehouse management, logistics distribution, or the like.

In addition, in one embodiment of the present disclosure, a picking-out operation region may be divided into a plurality of picking-out regions, and each selector (which may be a picking-out worker, an intelligent picking-out device, for example, a picking-out robot, or the like) may be responsible for sorting articles of at least one picking-out region. In addition, a plurality of selectors may be jointly responsible for one picking-out region. Such a division of the picking-out operation region may reduce a walking distance of the selector, increase an operation efficiency of each picking-out operation, and reduce a cost of each picking-out operation.

Optionally, the picking-out operation region may be divided into a plurality of picking-out regions according to a quantity of picking-out operations and/or a required picking-out operation time, or the like.

In addition, the selector may be deployed and scheduled according to actual demands (for example, the operation quantity, the operation time, or the like), for example, for a picking-out region with a large operation quantity and an requirement for a short operation time, a plurality of intelligent picking-out devices may be used to work in cooperation with a picking-out rule person.

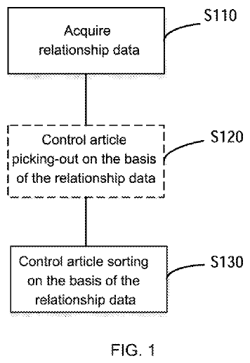

A control method for article sorting according to an exemplary embodiment of the present disclosure will be described below with reference to FIG. 1. The article sorting method may be performed by a control device for article sorting, which may be implemented as, for example, a computer, a server, a tablet computer, a mobile or fixed terminal, a wearable device, or the like.

As shown in FIG. 1, in step S110, relationship data at least used for reflecting a correspondence between an article list including labels of articles to be sorted and a sorting machine is acquired.

In step S130, on the basis of the obtained relationship data, the articles to be sorted which have been picked out are controlled to be conveyed to the corresponding sorting machine.

By acquiring the correspondence between the article list and the sorting machine and controlling the articles to be conveyed to the sorting machine based on the correspondence, a degree of automation of an article sorting operation may be improved effectively, and an operation efficiency may be increased greatly.

Optionally, the above-mentioned relationship data may further reflect at least one of the following relationships: a correspondence between the article list including the labels (identifications) of the articles to be sorted and a container configured to contain the article in the picking-out region, a correspondence between the container and the sorting machine, and a correspondence among the article list, the container and the sorting machine.

Here, if there exists the correspondence between the article list and the sorting machine, the article in the article list (an article to be sorted which has been picked out at this time) may be controlled to be conveyed to the designated sorting machine; if there further exists the correspondence between at least one of the article list and the sorting machine and the container, the article in the article list (an article which is not picked out at this time) may be further controlled to be conveyed to the container, or the container or the article in the container (an article to be sorted which has been picked out at this time) may be further controlled to be conveyed to the sorting machine.

An exemplary embodiment of control over the conveyance of the article in the article list to the container as well as the conveyance of the container or the article in the container to the sorting machine based on the relationship data will be described below.

Here, the control over the conveyance of the article in the article list to the container as well as the conveyance of the container or the article in the container to the sorting machine has an object that placement of the article may be beneficially deployed in the picking-out process in a case where the articles listed on the article list are located in different picking-out regions, such that the articles on the same article list may be sorted more quickly.

Specifically, the control may be performed as follows in the exemplary embodiment.

As shown in FIG. 1, optionally, in step S120, picking out of the articles belonging to the same article list and located in different picking-out regions may be controlled based on the correspondence between the article list and the container obtained from the relationship data, such that the articles are picked out into the containers with a same label in corresponding picking-out regions.

Then, in step S130, the articles in the containers with the same label in different picking-out regions are controlled to be conveyed to the same sorting machine.

Thus, although the articles in the article list are located in different picking-out regions, since these articles are placed in the containers with the same label, such placement manner makes the relationship between the articles and the article list very clear, and also facilitates the sorting of the articles in the same list, and the sorting may be realized only by conveying the articles in the containers with the same label in different picking-out regions to the same sorting machine.

In conclusion, the exemplary embodiment may increase a sorting speed and greatly improve the degree of automation and the operation efficiency for sorting.

In addition, the above-mentioned label of the container may be a number, a color, a name, a pattern, or the like.

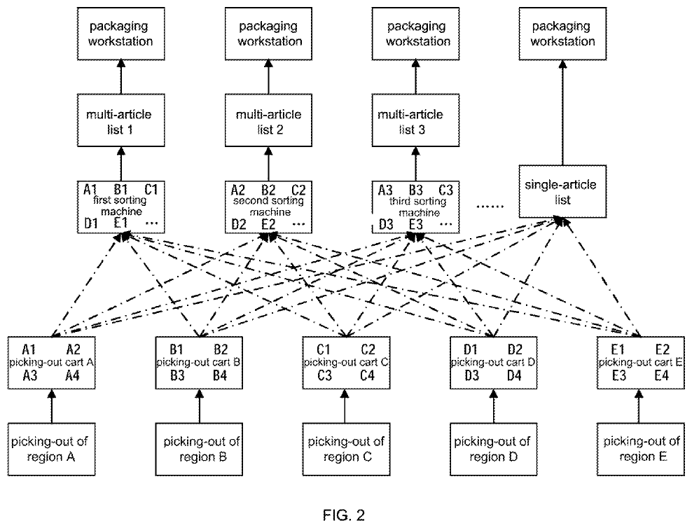

FIG. 2 shows an exemplary complete sorting process.

In the present example, the operation region is first divided into 5 picking-out regions A, B, C, D, E, and the picking-out operation for each picking-out region may be controlled. For example, the picking-out operations for the 5 picking-out regions may be performed in parallel.

For example, the picked-out articles may be controlled to be placed into the container. Optionally, articles in a multi-article list including labels of a plurality of different types of articles and a single-article list including only labels of one type of articles may be differently placed in different containers. Also, as shown in FIG. 2, the multi-article list and the single-article list may be handled separately. That is, the articles in the multi-article list may be picked out and then conveyed to the sorting machine to be sorted, while the articles in the single-article list may be picked out and then directly enter a link after the sorting, such as a packaging or distribution, without being conveyed to the sorting machine.

In this example, the container may be placed onto a picking-out cart in the picking-out region where the container is located, and more than one picking-out cart may exist in each region. However, the picking-out cart may not be provided in the picking-out region, and at this point, the containers are not required to be placed on the picking-out cart. Or some containers may be placed on the picking-out cart and some container are not placed on the picking-out cart, depending on actual picking-out and/or sorting demands.

The picking-out cart here may be configured as a manually pushed cart or a cart with an autonomous movement function.

In this example, the picked-out articles in the same list are controlled to be placed in the containers with the same label in different picking-out regions based on the correspondence between the article list and the containers obtained from the relationship data.

As shown in FIG. 2, the articles in a first article list located in the picking-out regions A-E are picked out and then placed in the container 1 in the region A (No. A1), the container 1 in the region B (No. B1), the container 1 in the region C (No. C1), the container 1 in the region D (No. D1), and the container 1 in the region E (No. E1), respectively.

Then, the articles in the containers with the same label in different picking-out regions (indicating that these articles are in the same article list) may be controlled to be conveyed to the same sorting machine. For example, as shown in FIG. 2, the articles listed in the multi-article list 1 as the first article list and placed in the container A1, the container B1, the container C1, the container D1, and the container E1 after picking-out are conveyed into the sorting machine 1. Up to now, the articles in the sorting machine 1 are all the articles in the above-mentioned first article list.

From the above, the articles may be automatically sorted efficiently, conveniently and fast by picking-out and placing the articles according to the correspondence among the article list, the container and the sorting machine.

In addition, the articles in the single-article list and the articles in the multi-article list may not be distinguished during picking-out as shown in FIG. 2, but may be mixed and then conveyed to the sorting machine first, and distinguished at the sorting machine, and such an exemplary embodiment will be described later.

In addition, optionally, the above-mentioned relationship data may be determined based on a current workload of each sorting machine. Here, the sorting operation of the sorting machine may be mainly determined on the basis of the current workload of each sorting machine, so as to equalize work of each sorting machine. For example, the workload of the sorting machine may include a number of the article lists corresponding to the sorting machine and/or a time required for the sorting operation of the article lists corresponding to the sorting machine.

After the article is picked out, the articles belonging to the single-article list picked out from each picking-out region may be conveyed to a next workstation which may be a manual sorting station or a packaging workstation, and instruction information may be output to instruct the worker to complete sorting and/or packaging work of the articles in the single-article list.

In some scenarios, when the articles are picked out in each picking-out region, each container only contains the articles belonging to one single-article list, and after picking-out is completed, the container corresponding to the single-article list may be directly conveyed to the packaging workstation to be packaged, as shown in FIG. 2.

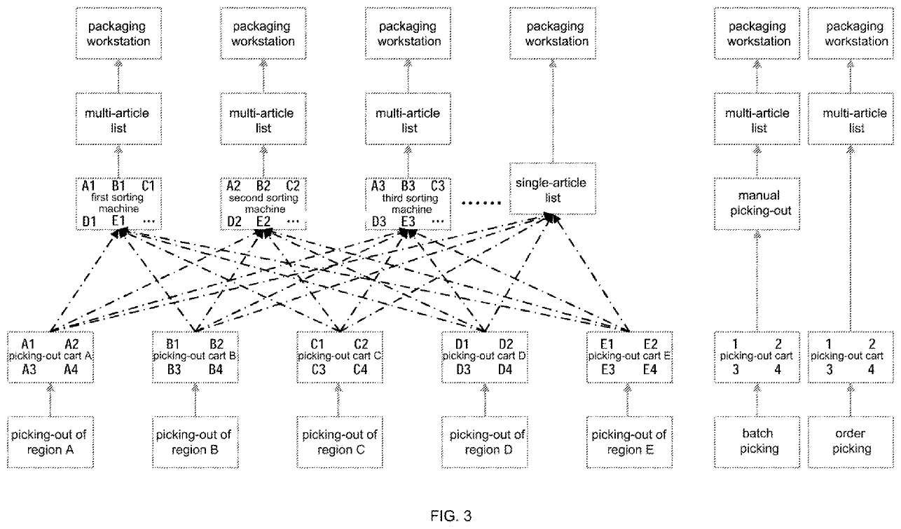

In some scenarios, when the articles are picked out in each picking-out region, one container may contain the articles belonging to a plurality of single-article lists, and after picking-out is completed, the container corresponding to the single-article lists may be first conveyed to the manual sorting station, and the worker is instructed to sort the articles in the container according to the single-article lists, and place the articles in each single-article list in a container individually to convey the container to the packaging workstation, as shown in FIG. 3.

Here, the articles in the article list to be sorted manually may be sorted using a batch-based picking-out method, a flow-based picking-out method, or an order-based picking-out method, as shown in FIG. 3.

In addition, optionally, the sorting machine used in the present embodiment may include different types of sorting machines, and each type of sorting machine may be configured to perform the sorting operation on an article list including a specified type of articles.

In addition, in the above-mentioned relationship data, the article lists including different specified types of articles may correspond to different types of sorting machines, such that different types of sorting machines are used for different types of articles, so as to not only perform the sorting operation conveniently and efficiently, but also avoid a sorting error or an accident.

In the above, the above-mentioned specified types of articles include a fragile type of articles, a non-fragile type of articles, or the like.

For example, different sorting approaches may be adopted by different types of sorting machines. Furthermore, different sorting approaches may be applied to different types of lists, such as the above-mentioned article list including the fragile type of articles, the article list not including the fragile type of articles, or the like.

In this case, during the determination of the correspondence between the article list and the sorting machine, the correspondence therebetween may be deployed taking into account the type of the list to which the sorting machine is adapted, so as to distribute different types of article lists to the appropriate sorting machines. For example, the sorting machine 1 may perform the sorting operation by throwing the article into a receiving apparatus (such as a bin, a cloth bag, or the like) below an article outlet, and such a sorting machine may be applied to the article list not including the fragile type of articles. As another example, the sorting machine 2 may perform the sorting operation by stably conveying the article into the receiving apparatus, and such a sorting machine may be applied to the article list including the fragile type of articles.

In addition, optionally, the above-mentioned sorting machine 1 may be implemented as, for example, a cross-belt sorting machine, a slider sorting machine, a disk sorting machine, or the like, and the article is moved to the outlet of the sorting machine, and slides via a sliding groove into the receiving apparatus placed below the outlet.

As another example, the sorting machine 2 may be implemented as a forklift, a robotic arm, or the like, and the article is stably placed into the receiving apparatus of a sorting wall using a fork or the robotic arm.

In addition, optionally, one of the following modes may be adopted to control the article on the container to be conveyed to the sorting machine.

1) The picking-out cart where the container is located is controlled to move the container to the sorting machine.

Here, the picking-out cart may be movable, and by controlling the movement of the picking-out cart, the container on the picking-out cart may be conveyed to the sorting machine.

2) the container or the article in the container is placed onto a conveying device which is controlled to convey the container or the article in the container to the sorting machine.

When this mode is adopted, the container may not be placed on the picking-out cart; that is, picking-out cart may not exist in the picking-out region where the container is located, or even if there exists a picking-out cart in the picking-out region, the container may not be placed on the picking-out cart. In this case, the container may be conveyed to the sorting machine using the conveying device, or the article in the container may be conveyed to the sorting machine.

In addition, the worker may be notified to place the article on the conveying device by means of characters, images, sounds, videos, or the like, output from a display screen, a loudspeaker, or the like. Or, an instruction may be issued to an automated device, such as a transfer robot, a robotic arm, or the like, and the automated device may place the article on the conveying device.

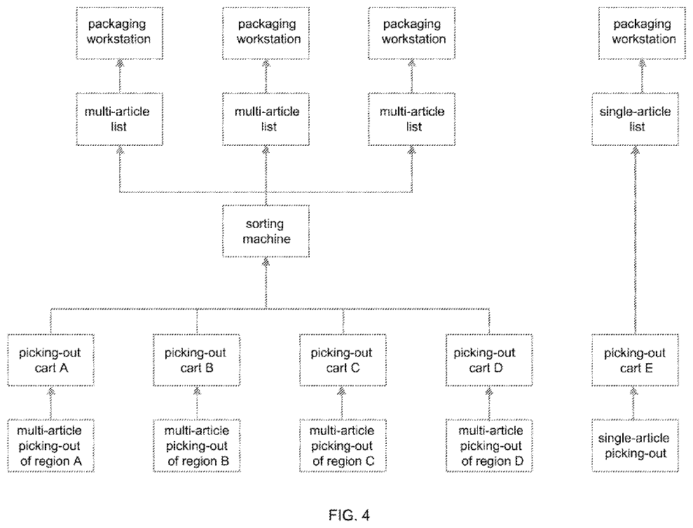

In addition, optionally, as shown in FIG. 4, the picked-out articles may be mixed (for example, multi-article picking-out as shown in FIG. 4), that is, the correspondence between the articles and the sorting machine and the container is not required to be determined during picking-out of the articles, and the articles corresponding to different sorting machines are not required to be placed into the corresponding containers as shown in FIG. 2. After the picking-out is finished, the article picked out in each picking-out region is conveyed to the sorting machine to be sorted. For example, all the picked-out articles may be conveyed to an ultra-large sorting machine (the sorting machine shown in FIG. 4) to be sorted thereby.

Here, as mentioned above, the article in the single-article list may still not be involved in the sorting process, but may directly enter the subsequent link, such as the packaging or distribution. That is, as shown in FIG. 4, the articles in each multi-article list may be mixed during picking-out, but the articles in the single-article list are picked out separately, that is, not mixed with the articles in the multi-article list, but placed separately, thus completing the operation for the single-article list efficiently and quickly.

In addition, the picked-out article may be conveyed to the sorting machine using the conveying device, and a rough sorting device may be provided on the conveying device, such that the articles may be diverted to a plurality of sorting machines according to article information, and the articles belonging to the same article list may be diverted to the same sorting machine. In addition, the above-mentioned article information may be obtained by a scanning operation using a scanning apparatus. For example, the scanning apparatus scans an identifier, such as a barcode, a two-dimensional code, an electronic tag, or the like, on an article packaging bag to acquire the article information.

That is, the operation of controlling the articles to be sorted which have been picked out in the article list to be conveyed to the corresponding sorting machine based on the relationship data in the above-mentioned step S130 includes: acquiring the labels of the articles to be sorted which have been picked out; and according to the labels of the articles to be sorted which have been picked out, conveying the articles belonging to the same article list to the same sorting machine based on the relationship data.

In addition, optionally, as mentioned above, for the single-article list only including one kind of articles, a specific container for containing the articles in the single-article list may be conveyed from the picking-out region to a specific workstation for appropriate treatment, such as direct packaging or distribution, of the specific container or the articles in the specific container. That is, during the picking-out, the articles in the single-article list may be individually placed in the specific container, and the specific container or articles may be directly conveyed to the packaging workstation without being sorted by the sorting machine.

Thus, processing links may be saved, a processing speed may be increased, and the operation efficiency may be improved.

Additionally, some specific article lists including specific types of articles may be suitable for being processed individually. For example, some specific article lists include hot goods, promotion goods, goods with a same list structure (i.e., same Stock Keeping Unit (SKU) information corresponding to the list), or the like, articles in such multi-article lists including specific types of articles may be picked out individually and manually sorted by the sorting machine, as shown in FIG. 4. By performing such individual treatment, the operation efficiency is higher.

That is, for the specific article list including the specific type of articles, the articles in the specific article list may be conveyed to a manual sorting station, and instruction information may be output to instruct the worker to perform the sorting operation.

The above-mentioned instruction information may include, for example, sounds, characters, images, videos, or other forms.

In the above, the above-mentioned specific type of articles may include at least one of: hot articles, promotion articles, articles with the same SKU information, the fragile type of articles, large articles, special-shaped articles, or the like. Since a higher efficiency is achieved when such special types of articles are individually processed manually, these articles are not required to be processed by a sorting machine in this case. In this way, an insufficient production capacity of the device in a peak period may be made up under special conditions (for example, conditions where a huge number of lists are generated in a short period, such as Double Eleven, an anniversary celebration, or the like), and a daily utilization rate of the device may be improved.

For example, in a scenario of an explosion of the number of the lists, such as a shop celebration, Double Eleven, or the like, some lists of articles required to be manually picked out, manually sorted and packaged may be determined according to a sorting workload of the sorting machine (please note that the article list is not limited to the above-mentioned list including specific types of articles), and the worker is then instructed to perform the corresponding operation on these lists, thus effectively meeting an operation flexibility requirement of the explosion of orders in a short period.

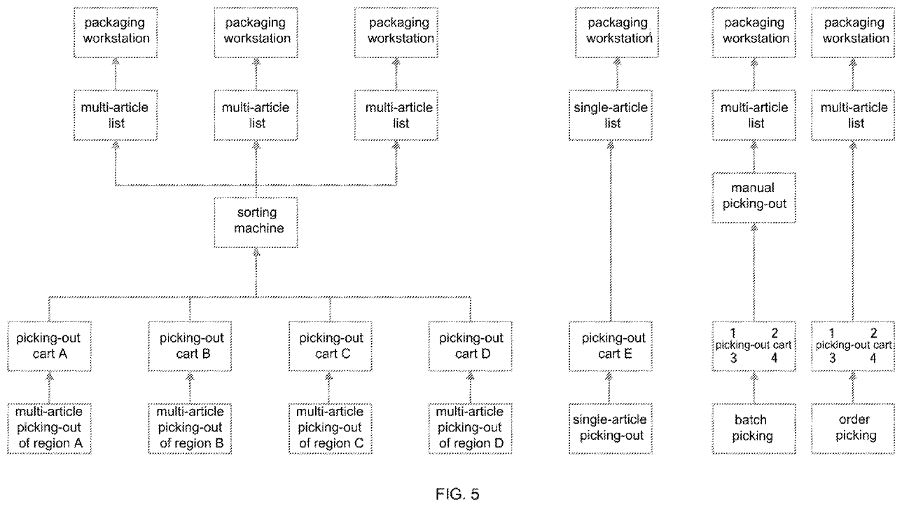

In addition, as shown in FIG. 5, the article in the article list required to be sorted manually may be picked out using various suitable picking-out methods or a combination of various picking-out methods, such as at least one of a batch picking method, a flow picking method, and an order picking method.

Here, the same SKU information corresponding to the lists means that the plurality of lists include the same articles; for example, the list A is composed of the article 1 and the article 2, and the list B is also composed of the article 1 and the article 2, such that the list A and the list B correspond to the same SKU information.

Thus, prior to picking-out, an article list including articles to be picked out may be acquired first, and then, a determination may be made as to whether the article in the article list is of a specific type of article.

If belonging to the specific type of article, the article in the article list is conveyed to the manual sorting station after picking-out is completed, as mentioned above.

On the contrary, if the article in the article list is not of the specific type of article, the relationship data for at least reflecting the correspondence between the article list and the sorting machine is acquired, such that the article picked-out for the article list is conveyed to the corresponding sorting machine based on the correspondence.

In addition, optionally, if some of the plurality of the picking-out carts in different picking-out regions, corresponding to several containers for containing the articles belonging to the same article list, are filled up, and the other picking-out carts are not filled up, generally, the other picking-out carts which are not filled up may be moved to the corresponding sorting machine after filled up. However, in order to increase the processing speed, even if the other picking-out carts are not filled up, these picking-out carts and the picking-out carts which are filled up may be instructed to move to the corresponding sorting machines at the same time, such that the articles in the same article list reach the sorting machine as soon as possible, so as to shorten the operation time, and improve the processing efficiency.

In addition, optionally, if the articles belonging to the same article list are located in a plurality of picking-out regions, and currently, picking-out in some of the plurality of picking-out regions has been completed but picking-out in the other picking-out regions is not completed, the articles belonging to this article list may be instructed to be preferentially picked out and conveyed in the other picking-out regions, such that the articles in the same article list reach the sorting machine as soon as possible, so as to shorten the operation time, and improve the processing efficiency.

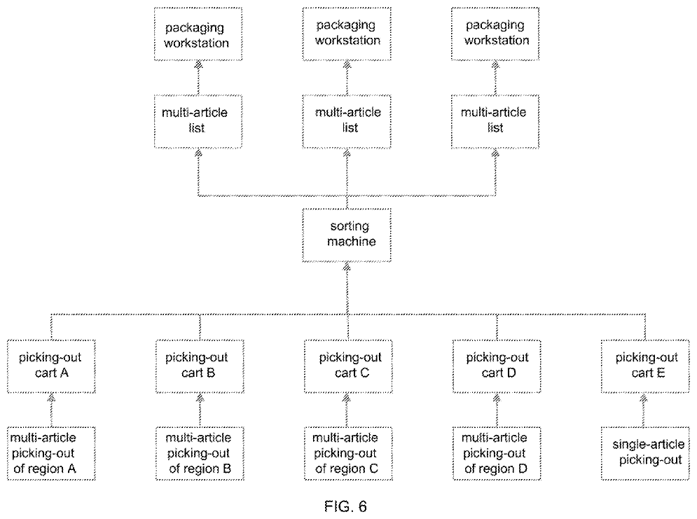

In addition, the articles obtained in the multi-article picking-out may be mixed as shown in FIG. 4, and the articles obtained in the multi-article picking-out may also be mixed with the articles obtained in the single-article picking-out as shown in FIG. 6. It should be noted that the mixing examples in FIGS. 4 and 6 represent only some mixing manners, and those skilled in the art should understand that the scope of the present disclosure should not be limited to the illustrated manner.

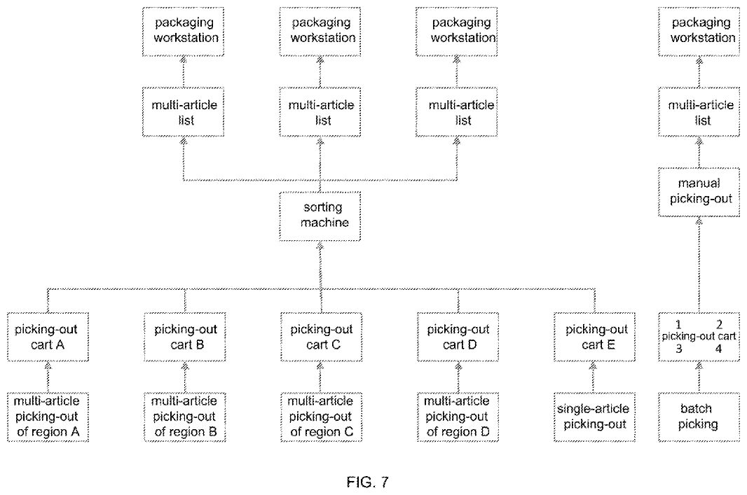

In addition to the mixing (mixing placement) of the articles in the single-article list and the multi-article list as shown in FIG. 6, in FIG. 7, manual picking-out may be performed for the specific article list including the specific type of articles, as mentioned above.

Furthermore, it should be noted that the examples of the article sorting process in FIGS. 2 to 7 are merely exemplary embodiments, and the present disclosure should not be limited to only such a few exemplary embodiments.

In addition, it should be noted that, optionally, the article may be rechecked after sorted, and conveyed to the packaging workstation to be packaged after the article list and the corresponding article are confirmed to be correct.

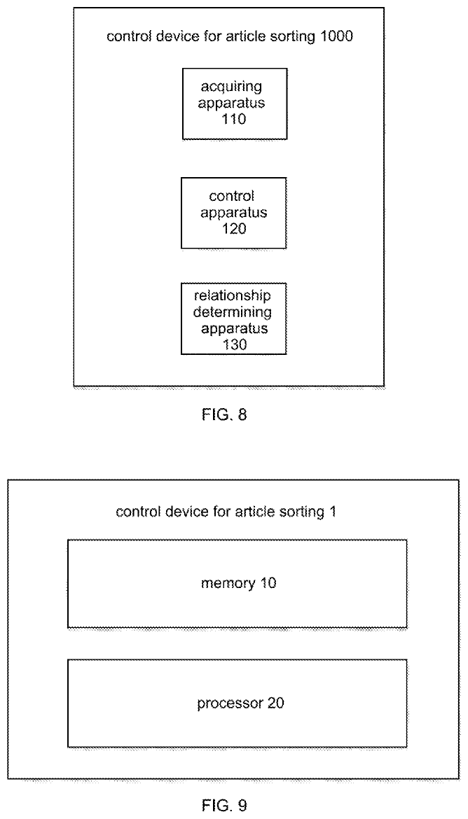

FIG. 8 is a schematic block diagram of a control device for article sorting according to an exemplary embodiment of the present disclosure. The control device for article sorting is configured to execute the control method for article sorting according to each of the above embodiments.

As shown in FIG. 8, the control device 1000 for article sorting may include an acquiring apparatus 110 and a control apparatus 120.

Here, the acquiring apparatus 110 may be configured to acquire relationship data at least used for reflecting a correspondence between an article list including labels of articles and a sorting machine.

The control apparatus 120 may be configured to, on the basis of the relationship data, control the articles to be sorted which have been picked out in the article list to be conveyed to the corresponding sorting machine.

Optionally, the control device for article sorting may further include a relationship determining apparatus 130 which may be configured to determine the correspondence between the article list and sorting machine based on a current workload of each sorting machine.

In addition, optionally, the relationship determining apparatus 130 may be further configured to determine a correspondence between the article list and a container for containing the article in a picking-out region, a correspondence between the container and the sorting machine, and a correspondence among the article list, the container and the sorting machine.

In addition, optionally, the control apparatus 120 may be further configured to: in a case where the articles in the article list are located in different picking-out regions, based on the correspondence between the article list and the container obtained from the relationship data, control the articles belonging to the same article list and located in different picking-out regions to be picked out into containers having the same label in corresponding picking-out regions, and control the articles in the containers having the same label in different picking-out regions to be conveyed to the same sorting machine.

In addition, optionally, the control apparatus 120 may control the article on the container to be conveyed to the sorting machine by one of the following manners:

1) a picking-out cart where the container is located is controlled to move the container to the sorting machine; and

2) the container or the article in the container is placed onto a conveying device, and the control apparatus controls the conveying device to convey the container or the article in the container to the sorting machine.

FIG. 9 is a schematic block diagram of a control device for article sorting according to another exemplary embodiment of the present disclosure. The control device for article sorting is configured to execute the control method for article sorting according to each of the above embodiments.

Referring to FIG. 9, the control device 1 for article sorting includes a memory 10 and a processor 20.

Optionally, the control device 1 for article sorting may further include a transceiver which may be in communication with other devices; for example, the transceiver may send operation instructions to at least one of a worker, the sorting machine, an automated picking-out device, the picking-out cart and the conveying device, so as to instruct and control at least one of the worker, the sorting machine, the automated picking-out device, the picking-out cart and the conveying device to perform a corresponding operation. For example, the control device 1 for article sorting sends the operation instruction through the transceiver, which may control the sorting machine to perform the sorting operation, or control the automated picking-out device to pick out articles in a multi-article list and/or a single-article list in the picking-out region, or control the picking-out cart to move to a destination, or control the conveying device to convey a specified article or container to a destination (for example, the sorting machine, a packaging workstation, or the like). The transceiver may also receive feedback information sent by at least one of the sorting machine, the automated picking-out device, the picking-out cart, and the conveying device.

Optionally, the control device 1 for article sorting may further include an output device including a display screen and/or a loudspeaker, and the output device may output prompt information for prompting the worker to perform the corresponding operation.

The processor 20 may be a multi-core processor or include a plurality of processors. In some embodiments, the processor 20 may include a general-purpose host processor and one or more special co-processors, such as a Graphics Processing Unit (GPU), a Digital Signal Processor (DSP), or the like. In some embodiments, the processor 20 may be implemented using custom circuitry, such as an Application Specific Integrated Circuit (ASIC) or a Field Programmable Gate Arrays (FPGA).

The memory 10 has an executable code stored thereon, which when executed by the processor 20, causes the processor 20 to perform one of the above-mentioned methods. In the above, the memory 10 may include various types of storage units, such as a system memory, a Read Only Memory (ROM), and a permanent storage apparatus, wherein the ROM may store static data or instructions required by the processor 20 or other modules of a computer. The permanent storage apparatus may be a read-write storage apparatus. The permanent storage apparatus may be a non-volatile storage apparatus which does not lose stored instructions and data even after the computer is powered down. In some embodiments, a mass storage apparatus (for example, a magnetic or optical disk, and a flash memory) is used as the permanent storage apparatus. In other embodiments, the permanent storage apparatus may be a removable storage device (for example, a floppy disk, and an optical disk driver). The system memory may be a read-write storage device or a volatile read-write storage device, such as a dynamic random access memory. The system memory may store some or all of instructions and data required by the processor during operation. Furthermore, the memory 10 may include any combination of computer-readable storage media, including various types of semiconductor memory chips (a DRAM, a SRAM, a SDRAM, a flash memory, and a programmable read only memory), and magnetic disks and/or optical disks may also be adopted. In some embodiments, the memory 10 may include a removable storage device which is readable and/or writable, such as a Compact Disc (CD), a read-only digital versatile disc (for example, a DVD-ROM, and a dual layer DVD-ROM), a read-only blue-ray disc, an ultra-density optical disc, a flash memory card (for example, a SD card, a min SD card, a Micro-SD card, or the like), a magnetic floppy disk, or the like. The computer-readable storage media do not include carrier waves and transitory electronic signals transmitted by wireless or wired means.

Furthermore, the embodiments according to the present disclosure may also be implemented as a computer program or computer program product including computer program code instructions for executing the above-mentioned steps defined in the methods according to the above-mentioned embodiments of the present disclosure.

Or, the present disclosure may also be implemented as a non-transitory machine-readable storage medium (or a computer-readable storage medium, or a machine-readable storage medium) having stored thereon an executable code (or a computer program, or a computer instruction code) which, when executed by a processor of an electronic device (or a computing device, a server, or the like), causes the processor to perform the each step of the above-mentioned method according to the present disclosure.

Those skilled in the art would further appreciate that various exemplary logical blocks, modules, circuits, and algorithm steps described in connection with the disclosure herein may be implemented as electronic hardware, computer software, or a combination of both.

The flowchart, block diagrams, or the like, in the figures illustrate the architecture, functionality, and operation of possible implementations of systems and methods according to various embodiments of the present disclosure. In this regard, each block in the flowchart or block diagrams may represent a module, program segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special-purpose hardware-based systems that perform the specified functions or acts, or combinations of special-purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or improvement over technologies found in the marketplace, or to enable others of ordinary skill in the art to understand the embodiments disclosed herein.

1. A control method for article sorting, comprising:
acquiring relationship data at least used for reflecting a correspondence between an article list comprising labels of articles and a sorting machine; and
controlling, based on the relationship data, articles to be sorted which have been picked out in the article list to be conveyed to a corresponding sorting machine.

2. The control method for article sorting according to claim 1,
wherein the relationship data further reflects at least one of following relationships: a correspondence between the article list and a container configured to contain articles in a picking-out region, a correspondence between the container and the sorting machine, and a correspondence between the article list, the container and the sorting machine.

3. The control method for article sorting according to claim 2,
wherein in a case where the articles in the article list are located in different picking-out regions, the method further comprises:
controlling articles belonging to a same article list and located in different picking-out regions to be picked out into containers with a same label in corresponding picking-out regions based on the correspondence between the article list and the container obtained from the relationship data, and
wherein the controlling, based on the relationship data, articles to be sorted which have been picked out in the article list to be conveyed to a corresponding sorting machine comprises:
controlling the articles in the containers with the same label in different picking-out regions to be conveyed to a same sorting machine.

4. The control method for article sorting according to claim 1,
wherein the relationship data is determined based on a current workload of each sorting machine.

5. The control method for article sorting according to claim 1, wherein the sorting machine comprises a plurality of different types of sorting machines, wherein each type of sorting machines is configured to perform a sorting operation on an article list comprising a specified type of articles, and
in the relationship data, article lists comprising different specified types of articles correspond to different types of sorting machines.

6. The control method for article sorting according to claim 5, wherein the specified types of articles comprise a fragile type of articles and a non-fragile type of articles.

7. The control method for article sorting according to claim 3, wherein one of following modes a) or b) is adopted to control articles on the container to be conveyed to the sorting machine:
a) a picking-out cart where the container is located is controlled to move the container to the sorting machine; and
b) the container or the articles in the container are placed onto a conveying device, which is controlled to convey the container or the articles in the container to the sorting machine.

8. The control method for article sorting according to claim 1, wherein the controlling, based on the relationship data, articles to be sorted which have been picked out in the article list to be conveyed to a corresponding sorting machine comprises:
acquiring labels of the articles to be sorted which have been picked out; and
conveying, according to the labels of the articles to be sorted, articles belonging to a same article list to a same sorting machine based on the relationship data.

9. The control method for article sorting according to claim 1, further comprising:
conveying, for a single-article list only comprising one kind of articles, a specific container for containing the articles in the single-article list from a picking-out region to a specific workstation, so as to direct package or distribute the specific container or the articles in the specific container.

10. The control method for article sorting according to claim 1, further comprising:
determining a list of specific articles required to be sorted manually; and
conveying articles in the list of the specific articles to a manual sorting station, and outputting instruction information to instruct a worker to perform a sorting operation.

11. The control method for article sorting according to claim 10, wherein the list of the specific articles comprises articles of a specific type, wherein the articles of a specific type comprise at least one of: hot articles, promotion articles, articles with same stock keeping unit information, a fragile type of articles, large articles and special-shaped articles.

12. The control method for article sorting according to claim 11, further comprising:
acquiring a list of articles to be picked out; and
determining whether the article list comprises the article of a specific type,
wherein if the article list comprises the article of a specific type, after picking-out is finished, the articles in the article list are conveyed to the manual sorting station; and if the article list does not comprise the article of a specific type, the relationship data at least used for reflecting the correspondence between the article list and the sorting machine is acquired.

13. The control method for article sorting according to claim 1, wherein the articles in the article list are located in a plurality of picking-out regions, and the plurality of picking-out regions are obtained by dividing a picking-out operation region according to a picking-out operation quantity and/or a required picking-out operation time.

14. The control method for article sorting according to claim 13, further comprising:
instructing the other picking-out carts which are not filled up and some of picking-out carts which have been filled up to move to corresponding sorting machines at the same time, or instructing the other picking-out carts which are not filled up to move to a corresponding sorting machine after filled up, if some of a plurality of picking-out carts in different picking-out regions, corresponding to several containers for containing articles belonging to a same article list, have been filled up, and the other picking-out carts are not filled up.

15. The control method for article sorting according to claim 14, further comprising:
instructing articles belonging to an article list to be preferentially picked out and conveyed in the other picking-out regions, if the articles belonging to the same article list are located in a plurality of picking-out regions, and currently, picking-out in some of the plurality of picking-out regions have been completed but picking-out in the other picking-out regions is not completed.

16. (canceled)

17. A control device for article sorting, comprising:
a processor; and
a memory, having an executable code stored thereon, which when executed by the processor, causes the processor to perform the method according to claim 1.

18. A non-transitory machine-readable storage medium, having an executable code stored thereon, which when executed by a processor, causes the processor to perform the method according to claim 1.

19. The control method for article sorting according to claim 2, further comprising:
conveying, for a single-article list only comprising one kind of articles, a specific container for containing the articles in the single-article list from a picking-out region to a specific workstation, so as to direct package or distribute the specific container or the articles in the specific container.

20. The control method for article sorting according to claim 2, further comprising:
determining a list of specific articles required to be sorted manually; and
conveying articles in the list of the specific articles to a manual sorting station, and outputting instruction information to instruct a worker to perform a sorting operation.

21. The control method for article sorting according to claim 2, wherein the articles in the article list are located in a plurality of picking-out regions, and the plurality of picking-out regions are obtained by dividing a picking-out operation region according to a picking-out operation quantity and/or a required picking-out operation time.
